(19) United States
(12) Patent Application Publication
(10) Pub. No.: US 2015/0134504 A1
(43) Pub. Date: May 14, 2015

(54) Online Private Securities Marketplace Platform

(71) Applicant: FNEX, LLC, Indianapolis, IN (US)

(72) Inventor: Todd R. Ryden, Fishers, IN (US)

(21) Appl. No.: 14/537,355

(22) Filed: Nov. 10, 2014

Related U.S. Application Data
(60) Provisional application No. 61/902,259, filed on Nov. 10, 2013.

(51) Int. Cl. G06Q 40/04

(52) U.S. Cl. CPC G06Q 40/04
USPC 705/37

(57) ABSTRACT

A comprehensive electronic alternative investment marketplace is provided for aggregated private securities and alternative investment options which are listed by investment banks and fund managers. The online web-based platform aggregates private securities offerings for sale to certain accredited investors and institutional investors. The platform aggregates private offerings from multiple investment banks and funds on a secure platform with industry-leading encryption standards that enables a streamlined transaction process and transfer of funds. The platform facilitates investment opportunity discovery, evaluation, transaction and directing the flow of funds from existing investor accounts to complete the investment process.

### REFERENCE TO RELATED APPLICATION AND PRIORITY CLAIM

This application is a non-provisional of and claims priority to co-pending utility application No. 61/902,259, filed on Nov. 10, 2013, the entire disclosure of which is incorporated herein by reference.

### FIELD OF THE INVENTION

The present invention generally relates to the financial securities market, and particularly to the use of online technology to enabling issuers to offer and investors to purchase private securities via an online platform.

### BACKGROUND

Private securities can be any type of investment, including publicly traded stocks, bonds or funds to non-public investments offered by private parties. For the qualified investor, the process includes discovering the investment opportunity, evaluating the opportunity, conducting the sales/purchase transaction and directing the flow of funds from existing investor accounts to complete the investment process. These steps have traditionally been part of a laborious, time-consuming, paper-driven process. Savvy investors eager to close a deal have no desire to slog through this time-consuming process. Consequently, there is a need for an on-line platform that simplifies and facilitates the steps in a private securities transaction.

### SUMMARY

The present invention contemplates a comprehensive electronic alternative investment marketplace, which consists of aggregated private securities and alternative investment options which are listed by investment banks and fund managers. An online web-based platform aggregates private securities offerings for sale to accredited investors and institutional investors. The platform aggregates private offerings from multiple investment banks and funds on a secure platform with industry-leading encryption standards that enables a streamlined transaction process and transfer of funds. The platform facilitates investment opportunity discovery, evaluation, transaction and directing the flow of funds from existing investor accounts to complete the investment process.

### DESCRIPTION OF THE FIGURES

FIG. 1 is screen shot of a page for identifying investment categories for the user.

FIG. 2 is a screen shot of a page for user entry of accreditation information.

FIG. 3 is a screen shot showing deal tiles according to one aspect of the present invention.

FIG. 4 is a screen shot showing a deal search page with filter options to be applied to the search.

FIG. 5 is screen shot of a page of saved searches.

FIG. 6 is a screen shot of a portion of a page in the Virtual Deal Room of the present invention.

FIG. 7 is screen shot of a page conveying detailed information regarding a selected deal tile.

FIG. 8 is a screen shot of a portion of a page for the user to consummate an investment.

### DETAILED DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure encompasses any alterations and modifications to the illustrated embodiments and includes further applications of the principles of the disclosure as would normally occur to one skilled in the art to which this disclosure pertains.

### Homepage & Login

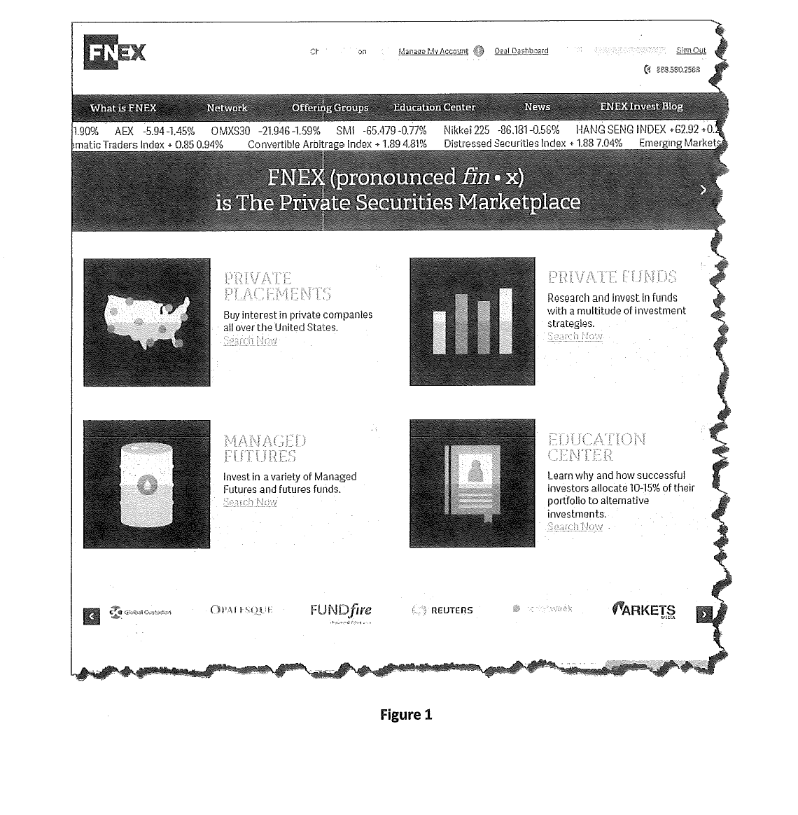

The present invention contemplates an on-line web-based platform to put qualified investors in contact with investment opportunities. For the purposes of the present disclosure, the web-based platform is identified as “FNEX” which corresponds to an on-line private securities marketplace according to the present invention. Users visit the FNEX homepage and can view the Barclay Hedge “ticker” displayed at the top of the page, as depicted in FIG. 1, which displays various indexes and stocks. The homepage provides links to a blog or education center so that the user can learn more about alternative securities and FNEX in general.

At the homepage, the user can then create an account or login. In one aspect, the account can be created using an email address, a Facebook account, or a LinkedIn account. FNEX follows a precise procedure for becoming a member in a manner that creates a substantitive relationship between the member and FNEX, as required by the SEC.

After selecting an account creation option, the user enters the appropriate credentials and, in the case of social account creation, authorizes FNEX to interact with the user's social profile. FNEX stores and retains all demographics and different aspects of the user's social profile. For the protection of all the parties, the user must agree to the Terms of Service (TOS) and Non-Disclosure Agreement (NDA). The FNEX investor marketplace is specifically configured to only allow accredited investors to become members. The FNEX platform verifies that the user has entered credentials that permit the user to engage in the securities transactions implemented by the FNEX platform.

Once an account is created, the user will receive a confirmation email message to ensure the user's email address (or the email address associated with the user's social media account) is valid. Once the user clicks the confirmation URL, the user's account is confirmed and the user is redirected to the FNEX login page.

After logging in, the user receives a welcome message indicating they are now signed in. The user can then select from different categories of alternative investments.

### Browsing Investment Offering

The FNEX platform categorizes investments. As illustrated in the screen-shot of FIG. 1, the available investment opportunities can include Private Placements, Managed Futures, and Private Funds. Additional investment opportunities can include Real Estate and Metals & Metals Depository categories.

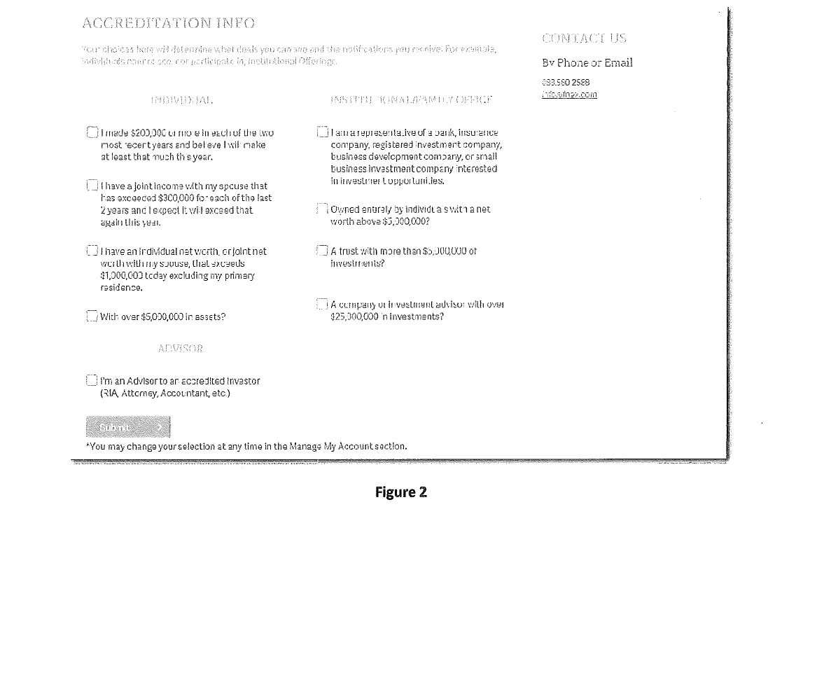

When the user makes a category selection, the user must complete an accreditation check, as shown in the screen-shot of FIG. 2. The user must identify whether the user is an Individual Investor, a Financial Advisor, or an Institutional Investor. FNEX works with issuers to classify individual investments to be available to one or more of these three groups. FNEX has the ability to completely control visibility to individual classes of investors on the platform.

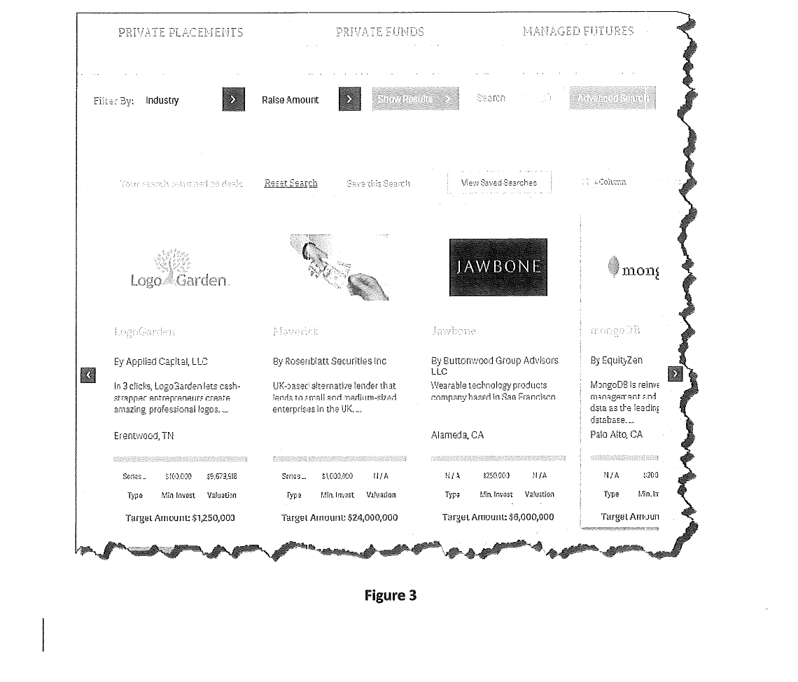

Once the user completes the accreditation check, the user can then view deal tiles according to the present disclosure. The FNEX platform uses deal tiles to present overview information for deals that the user is authorized to see (based on his/her accreditation), in the selected category, as shown in FIG. 3. The deal tile is context aware, showing different information based on the category of the deal.

For instance, for private placements, the deal tile shows:

Offering logo

Offering name

Listing Agency

Brief summary of the offering

Location of the offering

Investment Type

Minimum Investment

Current Valuation of the offering

Total amount the offering is seeking (Target Amount).

For private funds, the deal tile shows:

Offering logo

Offering name

Listing Agency

Brief summary of the offering

Location of the offering

Lockup period associated with the offering

Minimum investment

Return duration

Total amount the offering is seeking (Target Amount).

For managed futures, the deal tile shows:

Offering logo

Offering name

Listing Agency

Brief summary of the offering

Location of the offering

Investment Type

Minimum investment amount

Return duration

Total amount the offering is seeking (Target Amount).

By default, the FNEX platform shows the user four deal tiles at a time and allows the user to scroll horizontally to see more deal tiles. Alternatively, the platform allows the user to choose an eight deal tile layout.

### Searching for Investment Offerings and Creating Alerts

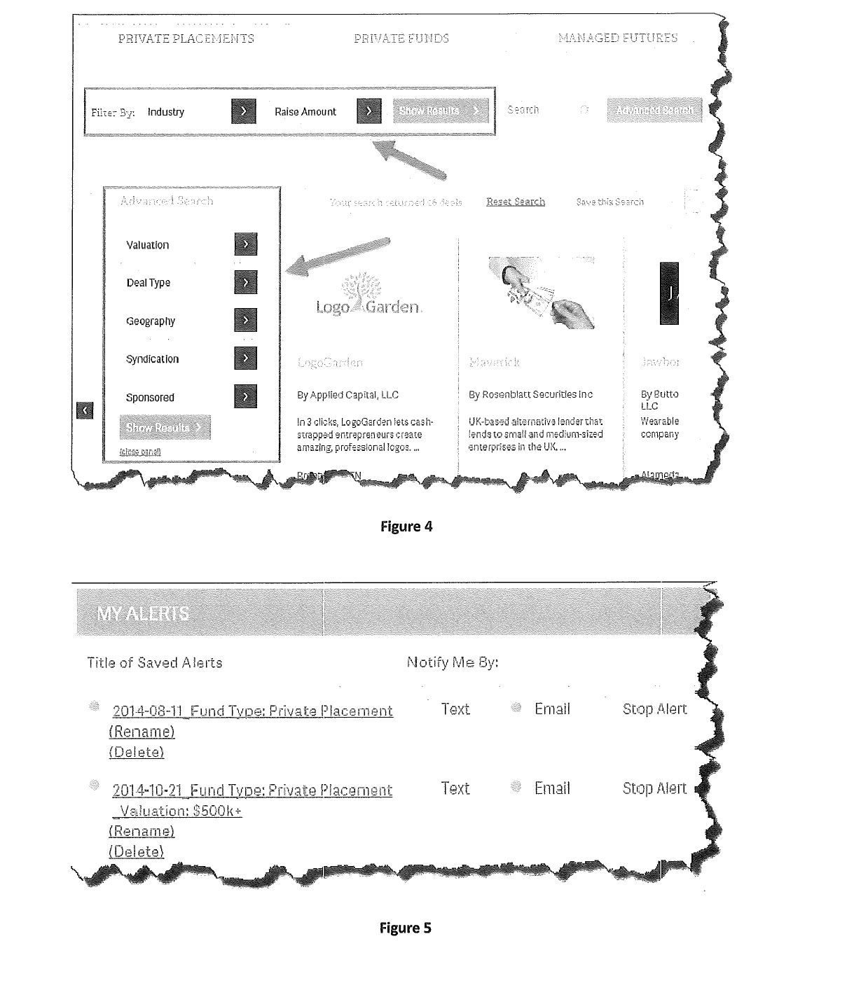

The user can filter the visible results based on various criteria using two drop down menus. For private placements, the user can filter by industry or raise amount, as shown in the screen shot of FIG. 4. For private funds, the user can filter by strategy or minimum investment. For managed futures, the user can filter by strategy or minimum investment. The appropriate investment can be selected using one of the radio bars at the top of the page.

The FNEX platform also provides an Advanced Search feature. Clicking the Advanced Search button (at the right of the screen shot in FIG. 4) produces a sidebar. The user can multi-select any criteria associated with deals to further filter and refine the user's visible deals. FIG. 4 shows the filters available with the advanced search criteria related to private placements, namely valuation, deal type, geography, syndication and sponsorship.

At any time, the user can opt to save any search. Once a search is saved, the user will receive a modal dialog box thanking the user for saving the search and explaining to the user that saved searches can be administered in Managed My Account. From the Manage My Account page, saved searches automatically create alerts, as selected by the user in the page shown in

FIG. 5. For instance, the user can be notified via email for any new listings that match the saved search criteria. If the user has shared a mobile number with the FNEX platform, the user can opt to receive SMS alerts as well. Users have the option to stop the alert but retain the saved search to quickly search all currently available deals that match the saved criteria. Further, users can rename or delete the saved search.

### Viewing Detailed Offering Information

At any point, a user can click on a deal tile (see FIG. 3) to view a deal detail page. On a deal detail page, much more detailed information about a particular investment offering is available to the user. Typically, videos, financials, more detailed descriptive text, leadership of the company or managers of the funds, lead investors, and web links to the offering are available to the user. The FNEX platform can also allow users to build a syndicate on the platform and chat in real time with other interested investors.

The FNEX platform allows the user can share a link to the deal via several social platforms and email. The deal is obfuscated in the link so that for others to see the investment requires becoming a member/user of the FNEX platform to ensure accreditation and compliance requirements are met. Once new users join, they are automatically redirected to the deal linked to them by a prior user.

Users can also identify favorite offerings. Once favorite, the deal tile associated with that offering will display a favorite flag indicating it is one of the user's favorite investment offerings. The user can see a complete list of favorites on the Manage My Account page. In addition to making an offering a favorite, the user can opt to be notified of any future webinars related to an investment offering by selecting the appropriate checkbox. Users can click an Express Interest button and a notification is sent to the Broker/Dealer Team at FNEX with all of the information about the potential investor and the investment offering. The Broker/Dealer Team can reach out directly to the potential investor and answer any questions and further qualify the user to invest in an offering. If someone from the Broker/Dealer Team approves the investor to actually invest in the offering, the Express Interest button changes to Invest.

### Virtual Deal Room

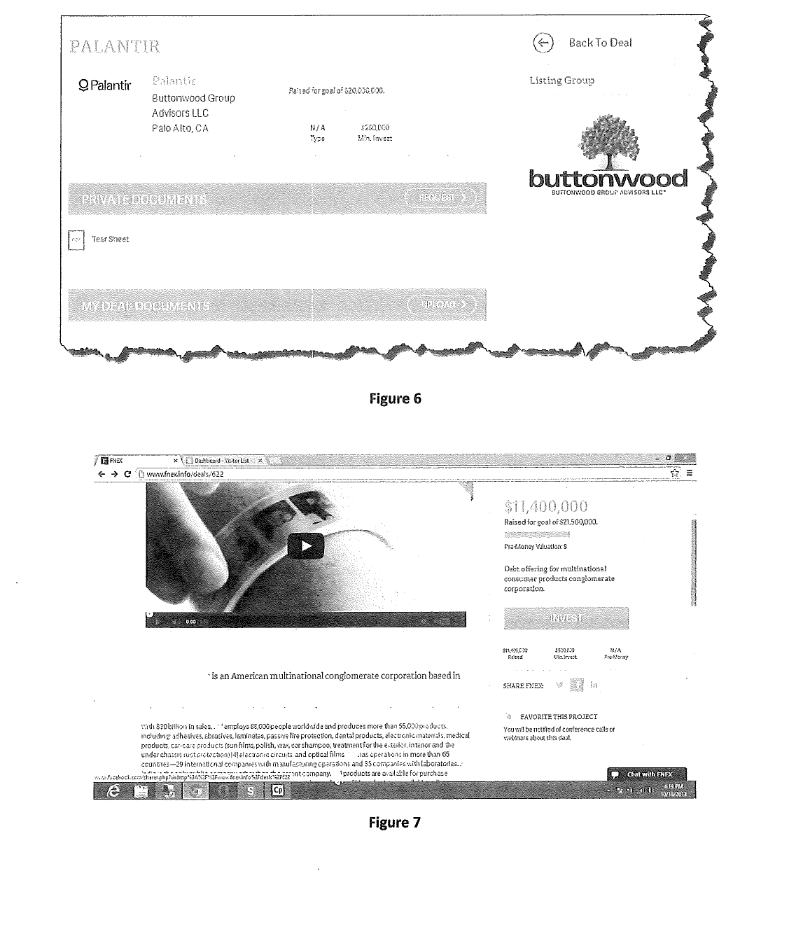

One important feature of the FNEX platform disclosed herein is the Virtual Deal Room (VDR). At any time, a user can request access to the Virtual Deal Room. Once approved, the user enters a secure deal room protected by industry-leading encryption standards. The user can see the Listing Group and any private documents related to the selected offering, as illustrated in the screen shot of FIG. 6. The user can request access to view any of those documents. Each listing group can also have an associated, custom Non-Disclosure Agreement (NDA) that the potential investor must digitally sign before viewing those protected documents. A member of the FNEX Broker/Dealer Team will work with the issuer to approve each individual investor prior to allowing the user to view the associated offering documents.

The user can also initiate a chat conversation with the offering owner on the FNEX platform. The platform will notify all the appropriate parties whenever additional correspondence is added. Users can upload their own documents as may be appropriate in negotiations conducted via the VDR.

### Investing in Deals

After a user has expressed interest in a deal and visited the Virtual Deal Room an agent from the FNEX Broker/Dealer Team vets the user and if the appropriate accreditation is found allows the user to invest in an individual offering. Once approved, the Express Interest button changes to an Invest button, as shown in the deal screen shot of FIG. 7.

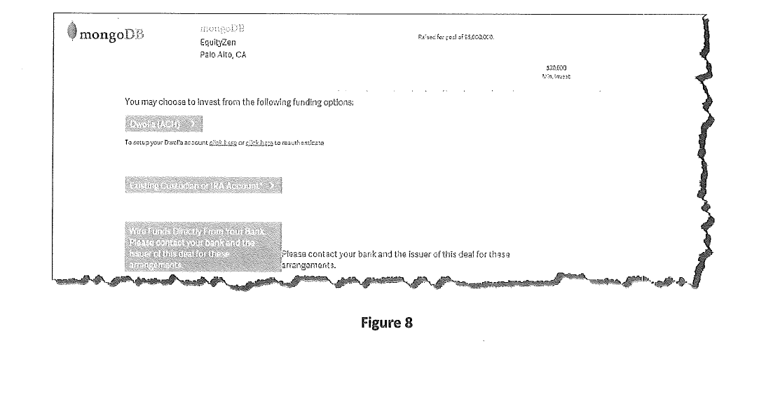

After the user clicks Invest, the user is presented with a funding options screen, as shown in FIG. 8. The screen allows the user to choose from multiple methods to fund an offering, such as using an Existing IRA/Custodian Account or simply wiring funds. The FNEX platform offers users the ability to select an existing IRA or other custodian account or create a new one with one of our partners. If the user selects this option, the user must enter appropriate information about the custodian account and FNEX will work directly with that custodian to transfer appropriate documentation to the custodian.

It is understood that the screen shots and the FNEX platform are created, generated and manipulated by appropriate software programs on a web-based or web-accessible computer or server. The software programs are adapted to receive input data from the user when working through the screens of the FNEX platform. The software programs further provide an avenue for the FNEX agents to populate the data base of securities accessible to the users, including uploading the documentation accessed through the VDR (FIG. 6). Software also maintains a data base of the user information and credentials.

The present disclosure should be considered as illustrative and not restrictive in character. It is understood that only certain embodiments have been presented and that all changes, modifications and further applications that come within the spirit of the disclosure are desired to be protected.

What is claimed is:

1. A method for performing private securities transactions, comprising:
providing user access to a data base of private securities investment opportunities via a secure communication network;
verifying the user's credentials to permit the user to engage in the investment opportunities via the secure communication network;
accessing a data base of investment opportunities and displaying a plurality of deal tiles providing information of investment opportunities available to the user;
upon selection of a deal tile by the user, accessing the data base via the secure communication network for stored information corresponding to the selected investment opportunity and displaying the information to the user in a virtual deal room (VDR);
upon selection by the user to invest in the investment opportunity corresponding to the selected tile, providing an interface to the user via the secure communication network to select a manner of payment for the investment; and
effecting transfer of the payment on behalf of the user to complete the private securities transaction.

2. The method for performing private securities transactions of claim 1, wherein the step of accessing a data base of investment opportunities includes permitting user selection from among classes of securities including private placements, private fund and managed futures, and displaying a plurality of deal tiles corresponding to securities within the user selected class of securities.

3. The method for performing private securities transactions of claim 2, wherein the deal tiles display the following information for each class of securities:
for private placements, offering logo, offering name, listing agency, brief summary of the offering, location of the offering, investment type, minimum investment amount, current valuation of the offering, and total amount the offering is seeking (Target Amount);
for private funds, offering logo, offering name, listing agency, brief summary of the offering, location of the offering, lockup period associated with the offering, minimum investment amount, return duration, and total amount the offering is seeking (Target Amount); and
for managed futures, offering logo, offering name, listing agency, brief summary of the offering, location of the offering, investment type, minimum investment amount, return duration, and total amount the offering is seeking (Target Amount).
